(19) United States
(12) Patent Application Publication
(10) Pub. No.: US 2026/0181125 A1
(43) Pub. Date: Jun. 25, 2026

(54) STEREOSCOPIC IMAGE DISPLAY DEVICE

(71) Applicant: LG DISPLAY CO., LTD., SEOUL (KR)

(72) Inventors: Wook Jeon, Daejeon (KR); JoungWon Woo, Goyang-si (KR); JuSeong Park, Gimpo-si (KR)

(21) Appl. No.: 19/374,229

(22) Filed: Oct. 30, 2025

(30) Foreign Application Priority Data
Dec. 20, 2024 (KR) 10-2024-0192782

(51) Int. Cl. H04N 13/307; H04N 13/32; H04N 13/324

(52) U.S. Cl. CPC H04N 13/307; H04N 13/32; H04N 13/324

(57) ABSTRACT

A stereoscopic image display device includes a substrate with a plurality of sub pixels each including an emission area, a light emitting diode disposed in the emission area of the substrate, a color filter disposed above the light emitting diode and overlapping the emission area. An optical member is disposed above the color filter and includes (i) a plurality of high refractive layers each having an upper side longer than a lower side and (ii) a plurality of low refractive layers disposed alternately between the high refractive layers, and an optical lens disposed above the optical member. A wider viewing angle can be ensured while maintaining the same resolution to improve a quality of an image which is three-dimensionally recognized to a user.

### CROSS-REFERENCE TO RELATED APPLICATIONS

Pursuant to 35 U.S.C. § 119(a), this application claims the benefit of an earlier filing date and right of priority to Korean Patent Application No. 10-2024-0192782 filed on Dec. 20, 2024, in the Korean Intellectual Property Office, the disclosure of which is incorporated herein by reference in its entirety for all purposes, as if fully set forth herein.

### TECHNICAL FIELD

The present disclosure generally relates to a stereoscopic image display device.

### BACKGROUND

A 3-dimensional (3 D) display can artificially reproduce a 3D screen or image. For example, the system can include both software techniques that display 3D content and hardware that implements the 3D content created by the software.

A virtual 3D display (hereinafter, referred to as a stereoscopic image display device) is a system which allows a user to virtually experience a three-dimensional effect on a flat display. It does this by utilizing binocular disparity, which is the slight difference in images seen by each eye separated by approximately 65 mm apart horizontally. This is one of the various factors that allow humans to perceive depth.

As an example, when a human looks at an object, each eye sees slightly different images (due to slightly different spatial information at the left and right sides) due to the binocular disparity and when these two images are transmitted to the brain through the retina, the brain precisely combines them to allow us to feel the three-dimensional effect. The stereoscopic image display device is a device which uses this concept to create a virtual three-dimensional effect through a design which simultaneously displays two images (e.g., left and right images) on a 2D display device to transmit the same to the eyes.

The description provided in the background section should not be assumed to be prior art merely because it is mentioned in or associated with the background section. The background section may include information that describes one or more aspects of the subject technology.

### SUMMARY

According to an aspect of the present disclosure, a stereoscopic image display device may include a substrate with a plurality of sub pixels each including an emission area, a light emitting diode disposed in the emission area of the substrate, a color filter disposed above the light emitting diode and overlapping the emission area. An optical member is disposed above the color filter and includes (i) a plurality of high refractive layers each having an upper side longer than a lower side and (ii) a plurality of low refractive layers disposed alternately between the high refractive layers, and an optical lens disposed above the optical member.

According to another aspect of the present disclosure, a stereoscopic image display device includes a substrate with a plurality of sub pixels, a light emitting diode disposed above the substrate, a color filter disposed above the light emitting diode, an optical member in which a plurality of high refractive layers and a plurality of low refractive layers are alternately disposed above the color filter, and an optical lens disposed above the optical member. Light from the light emitting diode is refracted at an interface between the low refractive layer and the high refractive layer at an angle larger than an incident angle to be incident on the optical lens.

Other detailed matters of the example implementations are included in the detailed description and the drawings.

Implementations of the present disclosure can provide various technical effects. For example, according to the present disclosure, a wider viewing angle is ensured while maintaining the same resolution to improve a quality of image which is three-dimensionally recognized by a user.

According to some implementations of the present disclosure, the flexibility of the lens design can be ensured and a highly immersive stereoscopic image can be implemented to enhance competitiveness in various markets, such as entertainment, education, and industrial applications.

The effects according to the present disclosure are not limited to the contents exemplified above, and more various effects are included in the present specification.

It is to be understood that both the foregoing general description and the following detailed description are examples and explanatory and are intended to provide further explanation of the inventive concepts as claimed.

### BRIEF DESCRIPTION OF DRAWINGS

FIG. 1 is a view schematically illustrating a stereoscopic image display device according to an example implementation of the present disclosure;

FIG. 2 is a circuit diagram of an example of a sub pixel of a stereoscopic image display device of FIG. 1;

FIG. 3 is a view enlarging an example of part A of FIG. 1;

FIG. 4 is a view illustrating an example of a cross-sectional structure of part A of FIG. 1;

FIG. 5 is a view illustrating an example of a FoV of a stereoscopic image display device of FIG. 1;

FIG. 6 is a view illustrating an example of a FoV according to a comparative scenario;

FIG. 7 is a graph illustrating an example of a luminance according to a viewing angle;

FIG. 8 is a graph illustrating an example of a luminance according to a viewing angle;

FIG. 9 is a cross-sectional view of a stereoscopic image display device according to another example implementation of the present disclosure; and

FIG. 10 is a cross-sectional view of a stereoscopic image display device according to still another example implementation of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Implementations of the present disclosure can provide a stereoscopic image display device, and more particularly, for example, without limitation, to a stereoscopic image display device including an optical lens.

A stereoscopic image display device may include an optical lens positioned over a light emitting diode. The optical lens can extend horizontally in one direction. For example, the optical lens may be a lenticular lens which implements a stereoscopic image in a light field manner.

Generally, a field of view (FoV) is determined by a lens shape and an optical gap. In a general light field display (LFD) structure, the lens pitch may be increased to expand the FoV. However, the disadvantage of increasing the pitch is that the 3D horizontal resolution decreases proportionally.

Implementations of the present disclosure can provide a stereoscopic image display device which expands the FoV while maintaining a 3D horizontal resolution.

According to some implementations, a stereoscopic image display device can overcome the limitations of the alternative LFD structures by implementing a clearer and more immersive stereoscopic image through a wider FoV.

According to some implementations, a stereoscopic image display device can provide a high quality stereoscopic image in various application fields (for example, AR/VR, medical images, simulation, and digital signage).

Aspects of the present disclosure are not limited to the above-mentioned aspects, and other aspects, which are not mentioned above, can be clearly understood by those skilled in the art from the following descriptions.

Reference will now be made in detail to implementations of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted. The progression of processing steps and/or operations described is an example; however, the sequence of steps and/or operations is not limited to that set forth herein and may be changed as is known in the art, with the exception of steps and/or operations necessarily occurring in a particular order. Names of the respective elements used in the following explanations may be selected only for convenience of writing the specification and may be thus different from those used in actual products.

Advantages and characteristics of the present disclosure and a method of achieving the advantages and characteristics will be clear by referring to example implementations described below in detail together with the accompanying drawings. However, the present disclosure is not limited to the example implementations disclosed herein but will be implemented in various forms. The example implementations are provided by way of example only so that those skilled in the art can fully understand the disclosures of the present disclosure and the scope of the present disclosure.

The shapes (e.g., sizes, lengths, widths, heights, thicknesses, locations, radii, diameters, and areas), ratios, angles, numbers, and the like illustrated in the accompanying drawings for describing the example implementations of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Components are interpreted to include an ordinary error range even if not expressly stated. Any implementation described herein as an “example” is not necessarily to be construed as preferred or advantageous over other implementations.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

In describing a time relationship, for example, when the temporal order is described as, for example, “after,” “subsequent,” “next,” and “before,” a case which is not continuous may be included unless a more limiting term, such as “just,” “immediate(ly),” or “direct(ly)” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

Although the terms “first”, “second”, “A,” “B,” “(a),” and “(b)” and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The term “at least one” should be understood as including any and all combinations of one or more of the associated listed items. For example, the meaning of “at least one of a first element, a second element, and a third element” compasses the combination of all three listed elements, combinations of any two of the three elements, as well as each individual element, the first element, the second element, or the third element.

The features of various implementations of the present disclosure can be partially or entirely adhered to or combined with each other and can be interlocked and operated in technically various ways, and the implementations can be carried out independently of or in association with each other.

Unless otherwise defined, all terms (including technical and scientific terms) used herein have the same meaning as commonly understood by one of ordinary skill in the art to which example implementations belong. It will be further understood that terms, such as those defined in commonly used dictionaries, should be interpreted as having a meaning, for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Hereinafter, an example implementation of the present disclosure will be described in detail with reference to the drawings.

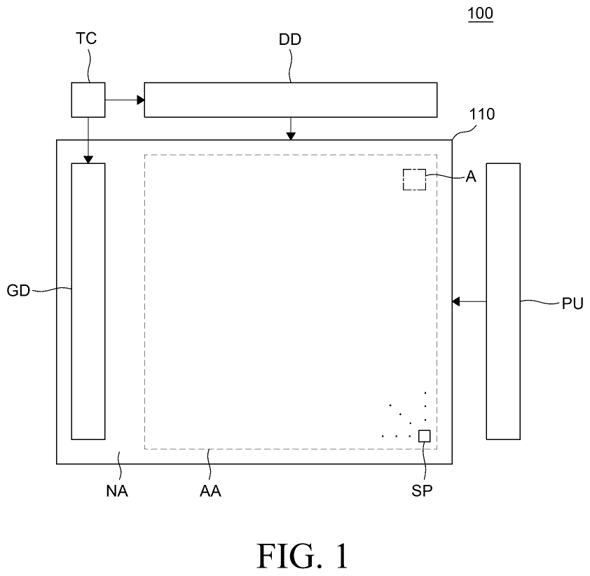

FIG. 1 is a view schematically illustrating a stereoscopic image display device according to an example implementation of the present disclosure.

Referring to FIG. 1, a stereoscopic image display device 100 according to the example implementation of the present disclosure may include a display panel 110.

The display panel 110 may be various types of display panels, such as an organic light emitting display panel or a liquid crystal display panel, without being limited thereto. Hereinafter, for the convenience of description, an organic light emitting display panel will be described as an example.

The display panel 110 may generate images to be provided to the user.

For example, in the display panel 110, a plurality of sub pixels SP may be disposed in a matrix. Various signals may be applied to each sub pixel SP through various signal lines GL, DL, and PL. For example, the signal lines GL, DL, and PL may include a gate line GL which applies a gate signal, a data line DL which applies a data signal, and a power voltage supply line PL which supplies a power voltage. Implementations are not limited thereto. As an example, one or more additional signal lines may be additionally or alternatively included.

The gate line GL may be electrically connected to the gate driver GD. Further, the data line DL may be electrically connected to the data driver DD.

The gate driver GD and the data driver DD may be controlled by a timing controller TC. The gate driver GD receives a clock signal, a reset signal, and a start signal from the timing controller TC and the data driver DD may receive digital video data and a source timing signal from the timing controller TC.

Further, the power voltage supply line PL may be electrically connected to a power unit PU.

The display panel 110 may include an active area AA in which a plurality of sub pixels SP is disposed and a non-active area NA located at the outside of the active area AA. For example, the non-active area NA may be disposed at the outside of the active area AA. For example, the active area AA may be partially or fully enclosed by the non-active area NA. As an example, the non-active area NA may be at least partially invisible from a front side of the display panel 110, for example, by being at least partially bent toward a rear side of the display panel 110, without being limited thereto. As an example, the non-active area NA may be flat.

The active area AA is an area in which an image is displayed in the stereoscopic image display device 100 and a display element and various driving elements for driving the display element may be disposed in the active area AA.

For example, the display element may be configured by a light emitting diode including a first electrode, an emission layer, and a second electrode.

Further, various driving elements for driving the display element, such as a thin film transistor, a capacitor, or a wiring line, may be disposed in the active area AA.

A plurality of sub pixels SP may be disposed in the active area AA. The sub pixel SP is a minimum unit which configures a screen and each of the plurality of sub pixels SP may include a light emitting diode and a driving circuit. Further, the plurality of sub pixels SP may emit light having different wavelengths. For example, the plurality of sub pixels SP may include at least one red sub pixel, at least one green sub pixel, and at least one blue sub pixel, but, it is not limited thereto and the plurality of sub pixels SP may further include at least one white sub pixel. Implementations are not limited thereto. As an example, sub pixels emitting light of colors other than red, green, blue and white, such as cyan, magenta, or yellow, etc., may be additionally or alternatively included.

Further, the driving circuit of the sub pixel SP is a circuit for controlling the driving of the light emitting diode. For example, the driving circuit may be configured to include a thin film transistor and a capacitor, but is not limited thereto.

The non-active area NA is an area where no image is displayed and various components for driving the plurality of sub pixels SP disposed in the active area AA may be disposed in the non-active area NA. For example, a driving IC which supplies a signal for driving the plurality of sub pixels SP and a flexible film may be disposed, without being limited thereto.

The non-active area NA may be an area which encloses the active area AA as illustrated in FIG. 1. However, it is not limited thereto, and for example, the non-active area NA may be an area extending from the active area AA.

The gate driver GD, the data driver DD, the timing controller TC, and the power unit PU may be located at the outside of the active area AA. For example, each signal line GL, DL, and PL may include an area located on the non-active area NA.

As an example, at least one of the gate driver GD, the data driver DD, the timing controller TC, and the power unit PU may be located on the non-active area NA, without being limited thereto. For example, in the stereoscopic image display device 100 according to the example implementation of the present disclosure, the gate driver GD may be formed as a gate in panel (GIP) type on the non-active area NA, but the present disclosure is not limited thereto. As an example, none of the gate driver GD, the data driver DD, the timing controller TC, and the power unit PU may be located on the non-active area NA. As an example, the gate driver GD may be provided on a separate panel or films, and connected to the display panel 110 in a tape automated bonding (TAB) method, a chip on glass (COG) method, a chip on panel (COP) method, or a chip on film (COF) method, without being limited thereto.

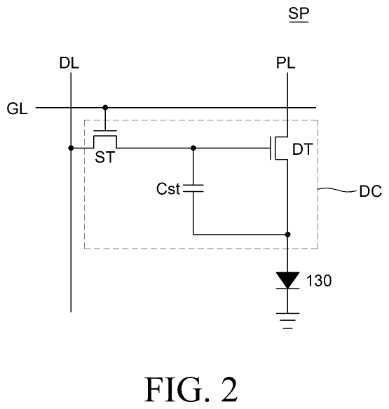

FIG. 2 is a circuit diagram of an example of a sub pixel of a stereoscopic image display device of FIG. 1.

Referring to FIG. 2, each sub pixel SP may emit light representing a specific color according to signals applied through the signal lines GL, DL, and PL.

For example, in each sub pixel SP, a driving circuit DC which is electrically connected to the light emitting diode 130 may be disposed. The driving circuit DC of each sub pixel SP may control the light emitting diode 130 of the corresponding sub pixel SP according to the signals applied through the signal lines GL, DL, and PL. For example, the driving circuit DC of each sub pixel SP may supply a driving current corresponding to a data signal to the light emitting diode 130 of the corresponding sub pixel SP according to the gate signal.

In some implementations, the driving current supplied by the driving circuit DC of each sub pixel SP may be maintained for a certain period (e.g., one frame). For example, the driving circuit DC of each sub pixel SP may include a first thin film transistor ST, a second thin film transistor DT, and a storage capacitor Cst. Implementations are not limited thereto. As an example, one or more thin film transistor or one or more storage capacitor may be further included.

The first thin film transistor ST of each sub pixel SP may transmit the data signal to the second thin film transistor DT of the corresponding sub pixel SP according to the gate signal. The first thin film transistor ST of each sub pixel SP may serve as a switching thin film transistor. The first thin film transistor ST may include a first active layer, a first gate electrode, a first drain electrode, and a first source electrode. For example, the first gate electrode of the first thin film transistor ST of each sub pixel SP is electrically connected to the corresponding gate line GL and the first drain electrode of the first thin film transistor ST of each sub pixel SP may be electrically connected to the corresponding data line DL.

The second thin film transistor DT of each sub pixel SP may generate a driving current corresponding to the data signal. As an example, the second thin film transistor DT of each sub pixel SP may serve as a driving thin film transistor. The second thin film transistor DT may include a second active layer, a second gate electrode, a second drain electrode, and a second source electrode. For example, the second gate electrode of the second thin film transistor DT of each sub pixel SP is electrically connected to the first source electrode of the first thin film transistor ST of the corresponding sub pixel SP and the second drain electrode of the second thin film transistor DT of each sub pixel SP may be electrically connected to the corresponding power voltage supply line PL.

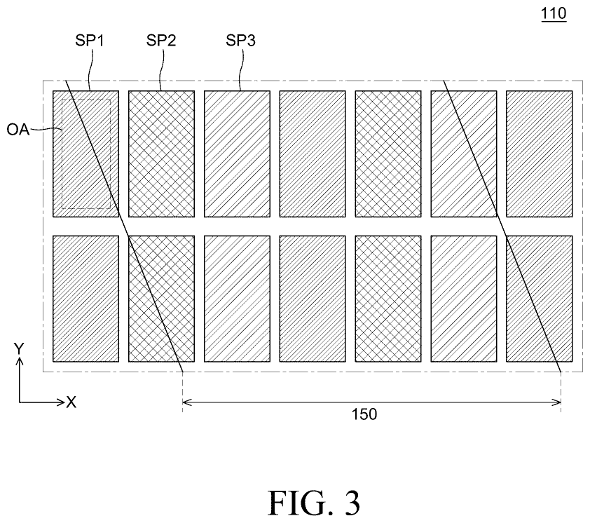

FIG. 3 is a view of an example of enlarging part A of FIG. 1.

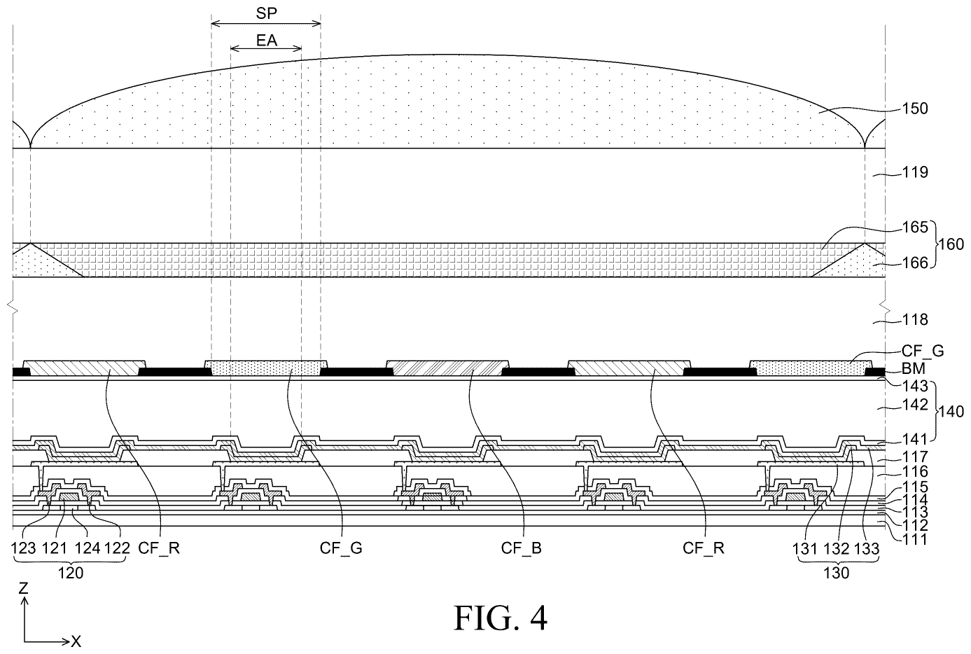

FIG. 4 is a view illustrating an example of a cross-sectional structure of part A of FIG. 1.

FIG. 3 illustrates a part of a display panel 110 in which 14 sub pixels SP1, SP2, and SP3 are disposed as an example. Further, FIG. 4 illustrates a part of a cross section of a display panel 110 in which five sub pixels SP1, SP2, and SP3 are disposed in one line as an example.

In FIGS. 3 and 4, it is illustrated that five sub pixels, including SP1, SP2, SP3, . . . (SP), correspond to one optical lens 150 as an example, but the present disclosure is not limited thereto and two or more or six or more sub pixels SP may correspond to one optical lens 150.

Referring to FIGS. 3 and 4, the display panel 110 according to the example implementation of the present disclosure may include a pixel area in which a plurality of sub pixels SP1, SP2, and SP3 is provided and a wiring area in which various signal lines are disposed.

A plurality of first sub pixels SP1, second sub pixels SP2, and third sub pixels SP3 may be disposed in the pixel area.

For example, the first sub pixel SP1 may be a red sub pixel.

For example, the second sub pixel SP2 may be a green sub pixel.

For example, the third sub pixel SP3 may be a blue sub pixel. The implementations are not limited thereto. As an example, the arrangement of the red sub pixel, the green sub pixel, the blue sub pixel may be changed in various ways, without being limited to those illustrated in FIGS. 3 and 4.

For example, the first sub pixel SP1, the second sub pixel SP2, and the third sub pixel SP3 may have a polygonal shape such as a rectangular shape, but are not limited thereto and the first sub pixel SP1, the second sub pixel SP2, and the third sub pixel SP3 may have various shapes, such as a circular shape or an oval shape.

In FIG. 3, it is illustrated that one first sub pixel SP1, one second sub pixel SP2, and one third sub pixel SP3 are gathered to configure one pixel, but is not limited thereto. As an example, one or more first sub pixel SP1, one or more second sub pixel SP2, and one or more third sub pixel SP3 may be gathered to configure one pixel. As an example, one or more white sub pixel or one or more sub pixels emitting light of other colors such as cyan, magenta, or yellow, etc., may be additionally or alternatively included in the one pixel, without being limited thereto.

The driving transistor 120, the switching transistor, and the light emitting diode 130 may be disposed above the substrate 111.

For example, the substrate 111 may include a first substrate, a second substrate, and an interlayer insulating film. The interlayer insulating film may be disposed between the first substrate and the second substrate. As described above, the substrate 111 is configured by the first substrate, the second substrate, and the interlayer insulating film to suppress the moisture permeation. For example, the first substrate and the second substrate may be polyimide (PI) substrates, but are not limited thereto. As an example, the substrate 111 may include one single substrate, or even three or more substrate. As an example, the substrate 111 may include a rigid substrate or a flexible substrate, without being limited thereto. As an example, the substrate 111 may include a transparent substrate or an opaque substrate, without being limited thereto.

A plurality of transistors, such as the driving transistor 120 and the switching transistor, may be disposed above the substrate 111.

The driving transistor 120 may be configured by an active layer 124, a gate electrode 121, a source electrode 122, and a drain electrode 123.

A buffer layer 112 may be disposed on the substrate 111. As an example, the buffer layer 112 may be omitted in some implementations depending on the design.

The active layer 124 may be disposed on the buffer layer 112.

A gate insulating layer 113 is disposed on the active layer 124.

The gate electrode 121 may be disposed on the gate insulating layer 113.

The interlayer insulating layer 114 may be disposed on the gate electrode 121.

The source electrode 122 and the drain electrode 123 of the driving transistor 120 may be disposed on the interlayer insulating layer 114.

In some implementations, the source electrode 122 and the drain electrode 123 may be electrically connected to a partial area of the active layer 124 through contact holes provided in the interlayer insulating layer 114 and the gate insulating layer 113, without being limited thereto.

A protection layer 115 may be disposed on the source electrode 122 and the drain electrode 123.

A planarization layer 116 may be disposed on the protection layer 115.

For example, the planarization layer 116 may include a first planarization layer and a second planarization layer, but is not limited thereto. As an example, the planarization layer 116 may include one single planarization layer or three or more planarization layers, without being limited thereto.

The planarization layer 116 may be configured by an organic material, such as acrylic resin or epoxy resin, and for example, may be configured by photo acryl (PAC), but is not limited thereto.

The anode 131 may be disposed on the planarization layer 116.

In one sub pixel SP, the planarization layer 116 and the protection layer 115 include contact holes and the drain electrode 123 of the driving transistor 120 and the anode 131 may be electrically connected through the contact holes.

The bank 117 may be disposed to cover a part of the anode 131.

For example, a part of the bank 117 corresponding to an emission area EA of the sub pixel SP may be open. As an example, the bank 117 may be disposed while covering both ends of the anode 131, without being limited thereto. As an example, the bank 117 may not cover the anode 131 while being in contact with a side surface of the anode 131, without being limited thereto.

For example, the bank 117 may include an open area OA obtained by removing (opening) a part corresponding to the emission area EA of a sub pixel SP. Further, for example, in the plan view, the open area OA may have a rectangular shape, but is not limited thereto, and may have various shapes, such as a circular shape or an oval shape.

For example, a part of the anode 131 may be exposed by the open area OA.

In the meantime, the emission area EA may have a shape corresponding to a shape of the open area OA. When a shape of an arbitrary component corresponds to a shape of the other component, it means that the shape of the arbitrary component has the same shape as the other component, or has the same shape, but has a different size, or a shape of the arbitrary component is formed by transferring the shape of the other component by an arbitrary method. Accordingly, the shape of the emission area EA is substantially understood to be obtained by transferring a shape of the open area OA by light emitted from the organic layer 132 located in the open area OA.

The bank 117 may be formed of a PI based material, but is not limited thereto.

At this time, as an example, a side portion of the bank 117 may have the same shape as an edge of the open area OA2. As an example, a side portion of the bank 117 may have the rectangular shape, which is substantially the same as the edge of the open area OA2, but the present disclosure is not limited thereto. For example, the side portion of the bank 117 may have various shapes, such as a circular shape or an oval shape.

For example, the organic layer 132 may be disposed in the open area OA of the bank 117 or in the vicinity thereof. For example, the organic layer 132 may be disposed on the anode 131 exposed through the open area OA of the bank 117. For example, the organic layer 132 may be disposed in the open area OA of the bank 117.

The organic layer 132 may be disposed only in the open area OA, but the present disclosure is not limited thereto and a part thereof may also be disposed on a top surface and a side portion of the bank 117.

The organic layer 132 may be configured with a single layered structure or a multi-layered structure. The organic layer 132 may include at least one emission layer (emission material layer: EML). The emission layer may include an organic emission material, an inorganic emission material, or a hybrid emission material. Further, for example, the organic layer 132 may further include at least one of a hole injection layer HIL, a hole transport layer HTL, an electron transport layer ETL, and an electron injection layer EIL, without being limited thereto. Therefore, the luminous efficiency of the emission layer may be improved.

The cathode 133 is disposed on the organic layer 132 and the cathode 133 may include a conductive material. The light emitting diode 130 including the anode 131, the organic layer 132, and the cathode 133 may be configured.

As an example, the cathode 133 may include a material different from that of the anode 131, or may include the same material as that of the anode 131. As an example, a transmittance of the cathode 133 may be higher than a transmittance of the anode 131, without being limited thereto. For example, the cathode 133 may be a transparent electrode formed of a transparent conductive material, such as ITO and IZO, without being limited thereto. Accordingly, as an example, in the stereoscopic image display device according to the example implementation of the present disclosure, light generated by the emission layer may be emitted through the cathode 133, without being limited thereto. Further, the cathode 133 may have a work function smaller than that of the anode 131, without being limited thereto.

In some implementations, an image displayed by light that is emitted from the light emitting diode 130 of each sub pixel SP may include various colors. As an example, light emitted from the light emitting diode 130 of each sub pixel SP may represent a different color from light emitted from a light emitting diode 130 of an adjacent sub pixel SP, without being limited thereto. For example, the emission area EA of each sub pixel SP may be one of a red emission area in which red light is emitted, a green emission area in which green light is emitted, and a blue emission area in which blue light is emitted. As an example, the emission layer of the organic layer 132 of each sub pixel SP may be spaced apart from an emission layer of an adjacent sub pixel SP, without being limited thereto. For example, the emission layer of each sub pixel SP may be one of a red emission layer which generates red light, a green emission layer which generates green light, and a blue emission layer which generates blue light. As an example, the organic layer 132 of each sub pixel SP may include a material different from that of an organic layer 132 of an adjacent sub pixel SP, without being limited thereto. Further, for example, the organic layer 132 of each sub pixel SP may include a laminated structure different from that of an organic layer 132 of an adjacent sub pixel SP, without being limited thereto. As an example, the organic layer 132 of each sub pixel SP may include an end portion located on the bank 117, without being limited thereto. As an example, the emission layer of the organic layer 132 of each sub pixel SP may be connected to an emission layer of an adjacent sub pixel SP. As an example, the emission layer of each sub pixel SP may be a white emission layer which generates white light. As an example, the organic layer 132 may have common layers (for example, the hole injection layer HIL, the hole transport layer HTL, the electron transport layer ETL, or the electron injection layer EIL) that continually extend on the top surface of the bank 117, without being limited thereto.

An encapsulation layer 140 may be disposed above the light emitting diode 130.

The encapsulation layer 140 may suppress a damage of the light emitting diode 130 disposed in each sub pixel SP due to external shocks and moisture.

In some implementations, the encapsulation layer 140 may have a single layered structure or a multi-layered structure, without being limited thereto. For example, the encapsulation layer 140 may include a first encapsulation layer 141, a second encapsulation layer 142, and a third encapsulation layer 143 which are sequentially laminated. The first encapsulation layer 141, the second encapsulation layer 142, and the third encapsulation layer 143 may include an insulating material. As an example, the second encapsulation layer 142 may include a material different from that of the first encapsulation layer 141 and the third encapsulation layer 143, without being limited thereto. For example, the first encapsulation layer 141 and the third encapsulation layer 143 include an inorganic insulating material and the second encapsulation layer 142 may include an organic insulating material. Accordingly, in the stereoscopic image display device according to the example implementation of the present disclosure, the damage of the light emitting diode 130 due to the external shocks and moisture may be effectively suppressed. A step caused by the light emitting diode 130 of each sub pixel SP may be removed by the second encapsulation layer 142. As an example, the second encapsulation layer 142 may have a thickness larger than that of the first encapsulation layer 141 and the third encapsulation layer 143, without being limited thereto. For example, a top surface of the encapsulation layer 140 which is opposite to the substrate 111 may be a flat plane. A top surface of the encapsulation layer 140 may be parallel to a top surface of the substrate 111.

As an example, color filters CF_R, CF_G, and CF_B may be disposed above the encapsulation layer 140.

Each color filter CF_R, CF_G, CF_B may overlap the emission area EA of each sub pixel SP. For example, the color filters CF_R, CF_G, and CF_B may include a red color filter CF_R, overlapping the red emission area, a green color filter CF_G overlapping the green emission area, and a blue color filter CF_B overlapping the blue emission area. Light generated by the light emitting diode 130 of each sub pixel SP may be emitted to the outside through the color filters CF_R, CF_G, and CF_B of the corresponding sub pixel SP. Accordingly, in the stereoscopic image display device according to the example implementation of the present disclosure, a color reproductivity may be improved.

The color filters CF_R, CF_G, and CF_B of each sub pixel SP may have a size larger than the emission area EA of the corresponding sub pixel SP. For example, the color filter CF_R, CF_G, and CF_B of each sub pixel SP may include an area located at the outside of the emission area EA defined in the corresponding sub pixel SP. At this time, the area located between adjacent emission areas EA may be defined as a non-emission area. For example, end portions of the color filters CF_R, CF_G, and CF_B located on each sub pixel SP may overlap the non-emission area. Accordingly, in the stereoscopic image display device according to the example implementation of the present disclosure, an amount of light emitted to the outside through the color filters CF_R, CF_G, and CF_B of each sub pixel SP may be increased. Accordingly, a light extraction efficiency may be increased.

A barrier layer BM may be disposed above the non-emission area of the encapsulation layer 140. For example, the barrier layer BM may overlap the bank 117. For example, the barrier layer BM may be disposed to be parallel to the color filters CF_R, CF_G, and CF_B. As an example, the barrier layer BM may be disposed in the same plane as the color filters CF_R, CF_G, and CF_B. Further, for example, the color filters CF_R, CF_G, and CF_B and the barrier layer BM may be in direct contact with the third encapsulation layer 143. An end portion of each color filter CF_R, CF_G, CF_B may partially overlap the barrier layer BM. For example, the barrier layer BM may include an area located between the third encapsulation layer 143 and the end portion of each color filter CF_R, CF_G, CF_B.

The barrier layer BM may include a material which blocks light. For example, the barrier layer BM may include a black dye, such as carbon black, without being limited thereto. Accordingly, in the stereoscopic image display device according to the example implementation of the present disclosure, light emitted from the light emitting diode 130 of each sub pixel SP toward the color filter CF_R, CF_G, CF_B of an adjacent sub pixel SP may be blocked by the barrier layer BM. Accordingly, in the stereoscopic image display device according to the example implementation of the present disclosure, light leakage due to emission of light which does not pass through the color filters CF_R, CF_G, and CF_B of each sub pixel SP may be suppressed. Further, in the stereoscopic image display device according to the example implementation of the present disclosure, unintended light mixture may be suppressed.

The first insulating layer 118 may be disposed above the color filters CF_R, CF_G, and CF_B and the barrier layer BM. The first insulating layer 118 suppresses damages of the color filters CF_R, CF_G, and CF_B and the barrier layer BM due to the external moisture and shocks.

For example, the first insulating layer 118 may be configured by an insulating material. Further, the first insulating layer 118 may be configured by a transparent insulating material. For example, the first insulating layer 118 may include an inorganic insulating material and/or an organic insulating material. A step caused by the color filters CF_R, CF_G, and CF_B and the barrier layer BM may be planarized by the first insulating layer 118. For example, a top surface of the first insulating layer 118 which is opposite to the encapsulation layer 140 may be flat. The top surface of the first insulating layer 118 may be parallel to the top surface of the encapsulation layer 140.

An optical member 160 may be disposed on the first insulating layer 118.

The optical member 160 may include a high refractive layer 165 and a low refractive layer 166.

The optical member 160 may be configured by repeatedly placing a plurality of high refractive layers 165 and a plurality of low refractive layers 166.

As an example, the high refractive layer 165 may have a trapezoidal shape, without being limited thereto.

For example, in the high refractive layer 165, an upper side may be longer than a lower side, as shown in FIG. 4. In this case, the upper side may refer to a side facing the optical lens 150 and the lower side may refer to a side facing the substrate 111. Each of the two furthest endpoints of the trapezoidal shape may be referred to as an upper vertex of the high refractive layer 165.

The high refractive layer 165 of the example implementation of the present disclosure may have an isosceles trapezoidal shape in which both base angles of the upper side are equal.

The plurality of high refractive layers 165 may be disposed in parallel (e.g., along the X-direction in FIGS. 3 and 4) along the top surface of the first insulating layer 118. The plurality of high refractive layers 165 may extend in one direction to be parallel. For example, as shown in FIG. 3, in the stereoscopic image display device according to the example implementation of the present disclosure, sub pixels SP1, SP2, and SP3 (SP) are located in parallel in a first direction X and a second direction Y perpendicular to the first direction X. Each high refractive layer 165 extends along an inclined direction relative to the first direction X and the second direction Y (see FIG. 3).

The low refractive layer 166 may be disposed between the plurality of high refractive layers 165. As an example, the low refractive layer 166 may be disposed between the plurality of high refractive layers 165 in a horizontal direction (e.g., in the X-direction in FIGS. 3 and 4). As an example, the low refractive layer 166 and the high refractive layers 165 are disposed in the same plane, without being limited thereto. As an example, the low refractive layer 166 and the high refractive layers 165 may have the same thickness, without being limited thereto. As an example, the interface between the low refractive layer 166 and the high refractive layers 165 may extend from a bottom surface of the optical member 160 to a top surface of the optical member 160, without being limited thereto. As an example, the low refractive layer 166 may have a triangle shape or a trapezoidal shape, without being limited thereto.

The plurality of low refractive layers 166 may be disposed in parallel (e.g., along the X-direction in FIGS. 3 and 4) along the top surface of the first insulating layer 118. The plurality of low refractive layers 166 may extend in one direction to be parallel. For example, each low refractive layer 166 may extend in an inclined direction relative to the first direction X and the second direction Y.

The high refractive layer 165 and the low refractive layer 166 are configured by an insulating material and the high refractive layer 165 may be configured by an insulating material having a refractive index higher than a refractive index of the low refractive layer 166. Further, the high refractive layer 165 and the low refractive layer 166 may be configured by a transparent insulating material.

A vertex of the upper side of the high refractive layer 165 may correspond to a boundary of the sub pixel SP, but is not limited thereto. As an example, a vertex of the upper side of the high refractive layer 165 may overlap the sub pixel SP, but is not limited thereto.

A second insulating layer 119 may be disposed on the high refractive layer 165 and the low refractive layer 166. For example, the second insulating layer 119 may be configured by an insulating material. The second insulating layer 119 may be configured by a transparent insulating material. For example, the second insulating layer 119 may include an inorganic insulating material and/or an organic insulating material.

An optical distance of light emitted from the light emitting diode 130 of each sub pixel SP may be sufficiently ensured by the first insulating layer 118 and the second insulating layer 119. For example, the first insulating layer 118 and the second insulating layer 119 may have a thickness larger than that of at least one of a plurality of insulating layers, such as buffer layer 112, gate insulating layer 113, interlayer insulating layer 114, protection layer 115, planarization layer 116, and bank 117 disposed between the substrate 111 and the encapsulation layer 140. A top surface of the second insulating layer 119 which is opposite to the first insulating layer 118 may be flat. For example, the top surface of the second insulating layer 119 may be parallel to the top surface of the first insulating layer 118.

A step caused by the optical member 160 may be planarized by the second insulating layer 119. For example, the second insulating layer 119 may have the same refractive index as that of the first insulating layer 118, without being limited thereto. As an example, the second insulating layer 119 may have the same material as that of the first insulating layer 118, without being limited thereto. As an example, at least one of the first insulating layer 118 and the second insulating layer 119 may be omitted depending on the design, without being limited thereto.

The optical lens 150 may be disposed on the second insulating layer 119. The optical lenses 150 may be disposed along the top surface of the second insulating layer 119 in parallel. The optical lenses 150 may extend in one direction while remaining parallel to each other. For example, in the stereoscopic image display device according to the example implementation of the present disclosure, sub pixels SP are located in parallel in a first direction X and a second direction Y perpendicular to the first direction X. Each optical lens 150 may extend in an inclined direction with respect to the first direction X and the second direction Y. As an example, each optical lens 150 may extend in parallel with the high refractive layer 165, without being limited thereto. As an example, each optical lens 150 may extend in an inclined direction the same as the inclined direction in which the corresponding high refractive layer 165 extends, without being limited thereto.

An image created by light emitted from the light emitting diode 130 of each sub pixel SP may be three-dimensionally recognized by the user by the optical lens 150. The optical lens 150 may be a lenticular lens. For example, the stereoscopic image display device of the example implementation of the present disclosure may be a light field display apparatus (LFD) which provides a stereoscopic image to a user in a light field manner using the optical lens 150.

For example, each optical lens 150 may overlap a plurality of sub pixels SP in the first direction X. The optical lens 150 may be formed by a reflow process, but is not limited thereto.

For example, five sub pixels SP arranged in the same line in the first direction X may overlap one of the plurality of optical lenses 150, but the present disclosure is not limited thereto. In this case, one optical lens 150 located above five sub pixels SP may have a size larger than a total size of five emission areas EA disposed in five sub pixels SP. As an example, one optical lens 150 may overlap the entirety of each of the five sub pixels SP arranged in the same line in the first direction X, or may overlap the entirety of each of four sub pixels SP arranged in the same line in the first direction X, while overlapping a part of each of two sub pixels SP arranged outside the four sub pixels SP in the first direction X, without being limited thereto.

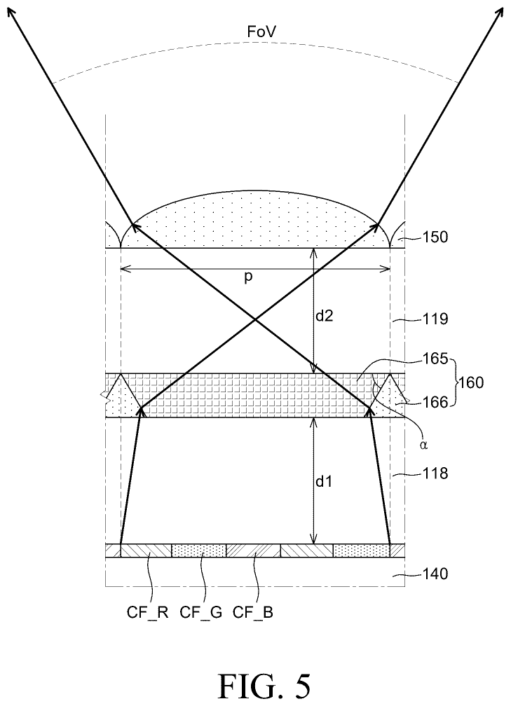

As described above, according to the example implementation of the present disclosure, light of the light emitting diode 130 which is incident from the bottom is greatly refracted from an interface of the low refractive layer 166 and the high refractive layer 165 of the optical member 160 so that a path of light is changed, which will be described in detail with reference to FIG. 5.

FIG. 5 is a view illustrating an example of a FoV of a stereoscopic image display device of FIG. 1.

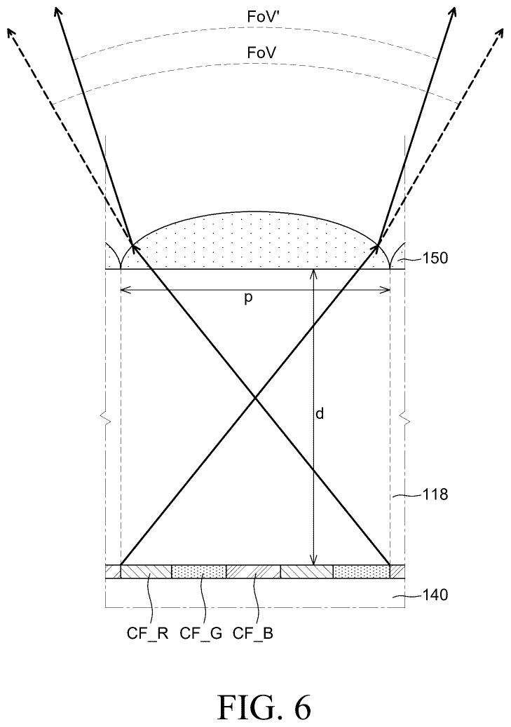

FIG. 6 is a view illustrating an example of a FoV according to a comparative scenario.

FIG. 6 shows a cross-sectional structure of a display panel according to a comparative scenario in which an optical member is omitted between the optical lens 150 and the color filters CF_R, CF_G, and CF_B together with a light traveling path, and for the convenience of description, a configuration below the encapsulation layer 140 is omitted.

FIG. 5 is a view showing a cross-sectional structure of a display panel 110 illustrated in FIG. 4 together with a light traveling path and for the convenience of description, a configuration below the encapsulation layer 140 is omitted.

First, referring to FIG. 5, color filters CF_R, CF_G, and CF_B may be disposed above the encapsulation layer 140.

Light generated by the light emitting diode of each sub pixel may be emitted to the outside through the color filters CF_R, CF_G, and CF_B of the corresponding sub pixel.

The first insulating layer 118 may be disposed above the color filters CF_R, CF_G, and CF_B.

For example, a refractive index of the first insulating layer 118 may be 1.5±10%.

The plurality of high refractive layers 165 may be disposed on the first insulating layer 118.

For example, the high refractive layer 165 has an inverted trapezoidal shape in which an upper side is longer than a lower side.

The high refractive layer 165 of the example implementation of the present disclosure may have an isosceles trapezoidal shape in which both base angles α of the upper side are equal.

At this time, for example, the base angle α of the upper side of the high refractive layer 165 may be 55±10%, in consideration of an error and a process margin.

Further, as an example, a length of the upper side of the high refractive layer 165 may be equal to a pitch P of the optical lens 150, but is not limited thereto.

The low refractive layer 166 may be disposed between the plurality of high refractive layers 165.

For example, the high refractive layer 165 may be configured by an insulating material having a refractive index higher than a refractive index of the low refractive layer 166.

For example, a refractive index of the high refractive layer 165 may be 1.64±10% and a refractive index of the low refractive layer 166 may be 1.40±10% in consideration of the error and the process margin. In this case, the refractive index difference between the high refractive layer 165 and the low refractive layer 166 may be approximately 0.23 to 0.25, and desirably, 0.24.

For example, the high refractive layer 165 may be configured by a UV curable photo polymer having a refractive index of 1.64±10% and the low refractive layer 166 may be configured by a UV curable photo polymer having a refractive index of 1.40±10%, without being limited thereto.

The second insulating layer 119 may be disposed on the optical member 160.

For example, a refractive index of the second insulating layer 119 may be 1.5±10%, without being limited thereto.

For example, the low refractive layer 166 may have a refractive index lower than that of the first insulating layer 118 and the second insulating layer 119. Further, for example, the high refractive layer 165 may have a refractive index higher than that of the first insulating layer 118 and the second insulating layer 119.

For example, the second insulating layer 119 is configured by photo acryl having a refractive index of 1.5±10%, without being limited thereto. Further, as an example, the second insulating layer 119 may be configured by a material which configures the encapsulation layer 140, without being limited thereto.

The optical lens 150 may be disposed on the second insulating layer 119.

A distance d1 between the optical member 160 and the color filter CF_R, CF_G, and CF_B, for example, a thickness of the first insulating layer 118 may be substantially equal to a distance d2 between the optical member 160 and the optical lens 150, for example, a thickness of the second insulating layer 119. As described above, the optical member 160 may be disposed within the same distance between the color filter CF_R, CF_G, and CF_B and the optical lens 150.

In the stereoscopic image display device according to the example implementation of the present disclosure configured as described above, light of the light emitting diode is greatly refracted from an interface of the low refractive layer 166 and the high refractive layer 165 of the optical member 160 to change the path of light.

This is because the high refractive layer 165 has an inverted trapezoidal shape in which an upper side is longer than a lower side so that light of a light emitting diode incident from the bottom is greatly refracted from the interface of the low refractive layer 166 and the high refractive layer 165 to change the path of light (see the arrow of FIG. 5). Therefore, according to the present disclosure, the path of light is widely dispersed by the optical member 160 while maintaining the same resolution to ensure a wider viewing angle.

Referring to FIG. 6, in the light field display (LFD) structure, a convex optical lens 150, such as a lenticular lens, is attached onto the display panel.

When a lens is designed to implement a stereoscopic image, generally, a field of view (FoV′) is determined according to a pitch P and an optical gap d of the optical lens 150.

In this case, in order to expand the field of view FoV′, generally, the pitch P of the optical lens 150 is increased. However, as the pitch P is increased, a horizontal resolution of the 3D may be degraded. This is because a horizontal size of a 3D pixel is determined by the pitch P of the optical lens 150. Therefore, if the pitch P of the optical lens 150 is extended to expand the field of view FoV', consequently, the horizontal resolution of the 3D may be degraded.

Referring to FIG. 5 again, according to an implementation of the present disclosure, the optical member 160 configured by the low refractive layer 166 and the high refractive layer 165 is disposed between the color filter CF_R, CF_G, and CF_B and the optical lens 150 to change the path of light which is directed from the light emitting diode to the optical lens 150, for example, disperse the light. Accordingly, an LFD having a wide field of view FoV is implemented while maintaining the same level of 3D horizontal resolution as the LFD of the comparative scenario.

Referring to FIGS. 5 and 6, it is understood that in the example implementation of the present disclosure, light of the light emitting diode 130 is greatly refracted at the interface of the low refractive layer 166 and the high refractive layer 165 to be incident to the optical lens 150 so that the field of view FoV is wider than that of the comparative scenario.

According to implementations of the present disclosure, a wider viewing angle is ensured while maintaining the same resolution to improve a quality of image which is three-dimensionally recognized by a user.

Further, according to implementations of the present disclosure, the flexibility of the lens design is ensured and a highly immersive stereoscopic image is implemented to enhance competitiveness in various markets, such as entertainment, education, and industrial applications.

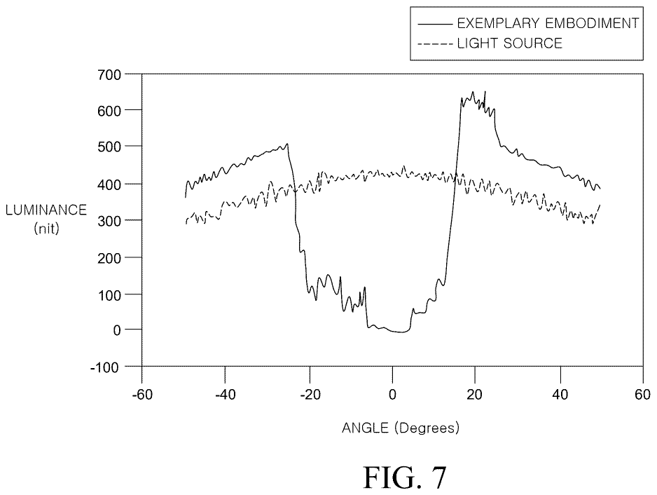

FIG. 7 is a graph illustrating an example of a luminance according to a viewing angle.

FIG. 7 illustrates a luminance change according to a luminance viewing angle of light from the light source and a luminance change according to a luminance viewing angle of an example implementation in which light of a light source passes through the optical member of the present disclosure together.

Referring to FIG. 7, it is understood that light from the light source has a luminance value which is reduced from a center portion toward a luminance viewing angle of-60 degrees or +60 degrees, but is gently reduced without being sharply reduced.

In contrast, when an optical member of the present disclosure is disposed above the light source, light from the light source is greatly refracted from the interface of the low refractive layer and the high refractive layer of the optical member so that light is concentrated in a viewing angle direction, rather than in the center portion. As an example, it is understood that the luminance value is sharply reduced in the center portion of the region of −20 degrees to +15 degrees. As an example, according to the present disclosure, light in the region of ±20 degrees is reduced and light is concentrated in the viewing angle direction.

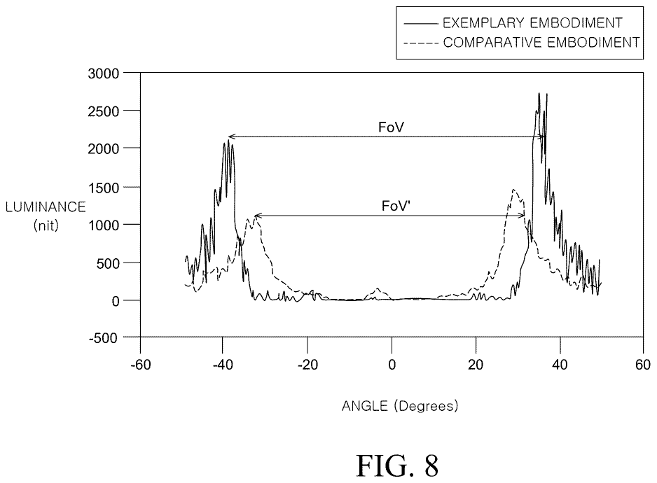

FIG. 8 is a graph illustrating an example of a luminance according to a viewing angle.

FIG. 8 illustrates a luminance change according to a luminance viewing angle of a comparative implementation in which light from the light source passes through the optical lens and a luminance change according to a luminance viewing angle of an example implementation in which light passes through the optical member and the optical lens of the present disclosure together.

Referring to FIG. 8, according to the example implementation, it is understood that an angle at which light enhanced in the viewing angle direction by the optical member is incident to the optical lens for implementing the LFD is increased so that finally, the field of view FoV wider than the field of view FoV′ of the comparative implementation is formed. For example, it is understood that when the field of view FoV′ of the comparative implementation is approximately 62°, the field of view FoV of the example implementation is improved to approximately 73°.

In the meantime, the present disclosure is also applied when the interface between the low refractive layer and the high refractive layer of the optical member is not a straight line, which will be described in detail with reference to the drawings.

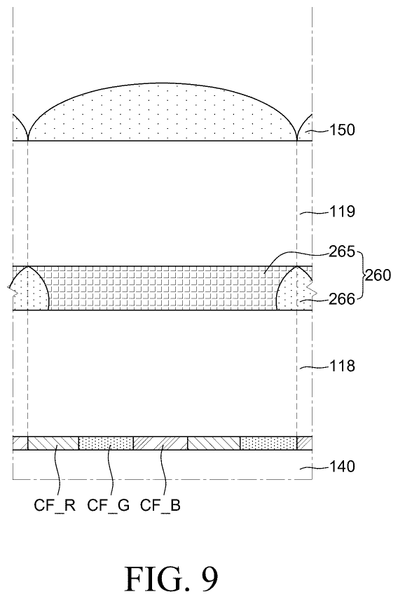

FIG. 9 is a cross-sectional view of a stereoscopic image display device according to another example implementation of the present disclosure.

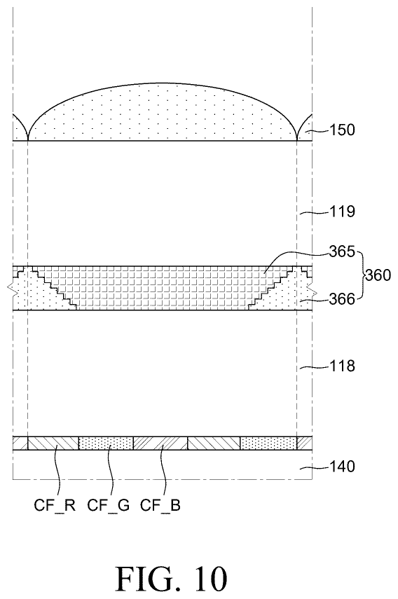

FIG. 10 is a cross-sectional view of a stereoscopic image display device according to still another example implementation of the present disclosure.

Another example implementation of the present disclosure of FIG. 9 and still another example implementation of the present disclosure of FIG. 10 are substantially the same as the example implementation of the present disclosure of FIGS. 1 to 5 except for a shape of an interface between a low refractive layer and a high refractive layer. Therefore, a redundant description will be omitted or briefly given. The same configuration will be denoted by the same reference numeral. Hereinafter, the description for the same reference numeral may refer to FIGS. 1 to 5.

In FIGS. 9 and 10, for the convenience of description, a configuration below the encapsulation layer 140 is omitted.

First, referring to FIG. 9, in a stereoscopic image display device of another example implementation of the present disclosure, an optical member 260 may be disposed on a first insulating layer 118.

The optical member 260 may include a high refractive layer 265 and a low refractive layer 266.

For example, in the high refractive layer 265, an upper side may be longer than a lower side.

The low refractive layer 266 may be disposed between the plurality of high refractive layers 265.

For example, the high refractive layer 265 may be configured by an insulating material having a refractive index higher than a refractive index of the low refractive layer 266.

According to another example implementation of the present disclosure, the interface between the low refractive layer 266 and the high refractive layer 265 of the optical member 260 is formed with a concave shape. For example, the interface between the low refractive layer 266 and the high refractive layer 265 may have a concave shape curved toward the high refractive layer 265. The concave shape may be a semi-circle or an oval. As an example, as described above, the interface between the low refractive layer 266 and the high refractive layer 265 is shaped concavely toward the high refractive layer 265 so that light of the light emitting diode is refracted to a greater extent at the interface of the low refractive layer 266 and the high refractive layer 265. Therefore, according to another example implementation of the present disclosure, the path of light is more widely dispersed by the optical member 260 while maintaining the same resolution to ensure a much wider viewing angle.

Referring to FIG. 10, in a stereoscopic image display device of another example implementation of the present disclosure, an optical member 360 may be disposed on a first insulating layer 118.

The optical member 360 may include a high refractive layer 365 and a low refractive layer 366.

For example, in the high refractive layer 365, an upper side may be longer than a lower side.

The low refractive layer 366 may be disposed between the plurality of high refractive layers 365.

For example, the high refractive layer 365 may be configured by an insulating material having a refractive index higher than a refractive index of the low refractive layer 366.

According to still another example implementation of the present disclosure, the interface between the low refractive layer 366 and the high refractive layer 365 of the optical member 360 is formed with a plurality of step shapes. As described above, because the interface between the low refractive layer 366 and the high refractive layer 365 has a plurality of step shapes, light of the light emitting diode is refracted from the interface of the low refractive layer 366 and the high refractive layer 365 in more various directions. Therefore, according to still another example implementation of the present disclosure, the path of light is more widely dispersed by the optical member 360 while maintaining the same resolution to ensure a much wider viewing angle.

The example implementations of the present disclosure can also be described as follows:

According to an aspect of the present disclosure, there is provided a stereoscopic image display device. The stereoscopic image display device includes a substrate divided into a plurality of sub pixels, a light emitting diode disposed above the substrate, a color filter disposed above the light emitting diode and overlapping the light emitting diode, an optical member disposed above the color filter and including a plurality of high refractive layers each having an upper side longer than a lower side and a plurality of low refractive layers alternately disposed in a horizontal direction and an optical lens disposed above the optical member.

At least a portion of each of the plurality of low refractive layers may be interposed between the high refractive layers and the color filter.

The high refractive layer may have an inverted trapezoidal shape.

The high refractive layer may have an isosceles trapezoidal shape.
The low refractive layer and the high refractive layers may be disposed in the same plane, and have the same thickness.

The low refractive layer may have a triangle shape or a trapezoidal shape, with both sides being in contact with high refractive layers.

The plurality of high refractive layers may extend in one direction in parallel with each other and the plurality of low refractive layers may extend in the one direction in parallel with each other.

The sub pixels may be arranged in a first direction and a second direction perpendicular to the first direction and the high refractive layer and the low refractive layer may extend in the one direction inclined with respect to the first direction and the second direction.

The high refractive layer may be configured by an insulating material having a refractive index higher than a refractive index of the low refractive layer.

The high refractive layer and the low refractive layer may be configured by a transparent insulating material.

A vertex of the upper side of the high refractive layer may correspond to a boundary of the sub pixel or overlaps the sub pixel.

The stereoscopic image display device may further comprise a first insulating layer disposed between the color filter and the optical member and a second insulating layer disposed on the optical member.

The low refractive layer may have a refractive index lower than that of the first insulating layer and the second insulating layer, and the high refractive layer may have a refractive index higher than that of the first insulating layer and the second insulating layer.

The optical lenses may extend in one direction in parallel with each other and may be inclined with respect to the first direction and the second direction.

The optical lenses may extend in parallel with the high refractive layer and the low refractive layer.

At least two sub pixels arranged in a line in a first direction among the plurality of sub pixels arranged in the first direction and a second direction perpendicular to the first direction may overlap one of the plurality of optical lenses.

A length of the upper side of the high refractive layer may be equal to a pitch of the optical lens.

The upper side of the high refractive layer may overlap the optical lens.

The optical member may be disposed at an equal distance with respect to the color filter and the optical lens between the color filter and the optical lens.

The interface between the high refractive layer and the low refractive layer may have a concave shape curved toward the high refractive layer.

The concave shape may be a semicircular shape or an oval shape.

The interface between the high refractive layer and the low refractive layer may have a plurality of step shapes.

A refractive index difference between the high refractive layer and the low refractive layer may be 0.23 to 0.25.

According to another aspect of the present disclosure, there is provided a stereoscopic image display device. The stereoscopic image display device includes a substrate divided into a plurality of sub pixels, a light emitting diode disposed above the substrate, a color filter disposed above the light emitting diode, an optical member in which a plurality of high refractive layers and a plurality of low refractive layers are alternately disposed in a horizontal direction above the color filter and an optical lens disposed above the optical member, light from the light emitting diode may be refracted at an interface between the low refractive layer and the high refractive layer at an angle larger than an incident angle with respect to the optical member to be incident on the optical lens.

The high refractive layer may have an inverted trapezoidal shape in which an upper side is longer than a lower side.

The interface between the high refractive layer and the low refractive layer may have a concave shape curved toward the high refractive layer.

The concave shape may be a semicircular shape or an oval shape. The interface between the high refractive layer and the low refractive layer may have a plurality of step shapes.

According to another aspect of the present disclosure, there is provided a stereoscopic image display device. The stereoscopic image display device may include a substrate divided into a plurality of sub pixels; a light emitting diode disposed above the substrate; a color filter disposed above the light emitting diode; an optical member disposed above the color filter; and an optical lens disposed above the optical member, light from the light emitting diode may be refracted by the optical member at an angle larger than an incident angle with respect to the optical member, to be incident on the optical lens.
The optical member may be disposed at an equal distance with respect to the color filter and the optical lens between the color filter and the optical lens.
The light from the light emitting diode may be refracted at an interface between a first refractive layer and a second refractive layer in the optical member, and the interface may extend inclinedly from a bottom surface of the optical member to a top surface of the optical member.

Although the example implementations of the present disclosure have been described in detail with reference to the accompanying drawings, the present disclosure is not limited thereto and may be embodied in many different forms without departing from the technical concept of the present disclosure. Therefore, the example implementations of the present disclosure are provided for illustrative purposes only but not intended to limit the technical concept of the present disclosure. The scope of the technical concept of the present disclosure is not limited thereto. Therefore, it should be understood that the above-described example implementations are illustrative in all aspects and do not limit the present disclosure. All the technical concepts in the equivalent scope of the present disclosure should be construed as falling within the scope of the present disclosure.

What is claimed is:

1. A stereoscopic image display device, comprising:
a substrate comprising a plurality of sub pixels;
a light emitting diode disposed above the substrate;
a color filter disposed above the light emitting diode and overlapping the light emitting diode;
an optical member disposed above the color filter and including (i) a plurality of first refractive layers each having an upper side longer than a lower side and (ii) a plurality of second refractive layers, wherein the plurality of first refractive layers and the plurality of second refractive layers are alternately disposed along a horizontal direction parallel to the substrate, and wherein a refractive index of the plurality of first refractive layers is higher than a refractive index of the plurality of second refractive layers; and
a plurality of optical lenses disposed above the optical member.

2. The stereoscopic image display device according to claim 1, wherein at least a portion of each of the plurality of second refractive layers is interposed between the plurality of first refractive layers and the color filter, in a cross-section view.

3. The stereoscopic image display device according to claim 1, wherein each of the plurality of first refractive layers has a shape from among a group consisting of an inverted trapezoidal shape, an isosceles trapezoidal shape, a triangle shape, and a trapezoidal shape.

4. The stereoscopic image display device according to claim 1, wherein the plurality of first refractive layers and the plurality of second refractive layers are disposed in the same plane parallel to the substrate, and have the same thickness, and
wherein the plurality of first refractive layers extend along one direction in parallel with each other and the plurality of second refractive layers extend along the one direction in parallel with each other.

5. The stereoscopic image display device according to claim 4, wherein the plurality of sub pixels are arranged along a first direction and along a second direction perpendicular to the first direction, and
wherein the plurality of first refractive layers and the plurality of second refractive layers extend in the one direction and are inclined with respect to the first direction and the second direction.

6. The stereoscopic image display device according to claim 1,
wherein the plurality of first refractive layers and the plurality of second refractive layers comprise a transparent insulating material.

7. The stereoscopic image display device according to claim 1, wherein a vertex of the upper side of each of the plurality of first refractive layers corresponds to a boundary of a respective sub pixel among the plurality of subpixel or overlaps the respective sub pixel.

8. The stereoscopic image display device according to claim 1, further comprising:
a first insulating layer disposed between the color filter and the optical member; and
a second insulating layer disposed on the optical member,
wherein the refractive index of the plurality of second refractive layers is lower than a refractive index of the first insulating layer and a refractive index of the second insulating layer, and
wherein the refractive index of the plurality of first refractive layers is higher than the refractive index of the first insulating layer and the refractive index of the second insulating layer.

9. The stereoscopic image display device according to claim 5, wherein the plurality of optical lenses extend in the one direction in parallel with each other and are inclined with respect to the first direction and the second direction.

10. The stereoscopic image display device according to claim 5, wherein the plurality of optical lenses extend in parallel with the plurality of first refractive layers and the plurality of second refractive layers.

11. The stereoscopic image display device according to claim 1, wherein the plurality of sub pixels are arranged along a first direction and along a second direction perpendicular to the first direction,
wherein at least two of the plurality of sub pixels are arranged in a line along the first direction and overlap one of the plurality of optical lenses.

12. The stereoscopic image display device according to claim 1, wherein a length of the upper side of a first refractive layer among the plurality of first refractive layers is equal to a pitch of a respective optical lens among the plurality of optical lenses, and
wherein the upper side of the first refractive layer overlaps the optical lens.

13. The stereoscopic image display device according to claim 1, wherein the optical member is disposed at an equal distance with respect to the color filter and the plurality of optical lenses, between the color filter and the plurality of optical lenses.

14. The stereoscopic image display device according to claim 1, wherein an interface is defined between (i) a first refractive layer among the plurality of refractive layers and (ii) an adjacent second refractive layer among the plurality of second refractive layers,
wherein the interface has a concave shape curved toward the high refractive layer, and
wherein the concave shape is a semicircular shape or an oval shape.

15. The stereoscopic image display device according to claim 1, wherein the interface between the first refractive layer and the adjacent second refractive layer has a plurality of step shapes.

16. The stereoscopic image display device according to claim 1, wherein a refractive index difference between refractive index of the plurality of first refractive layers and the refractive index of the plurality of second refractive layers is 0.23 to 0.25.

17. A stereoscopic image display device, comprising:
a substrate comprising a plurality of sub pixels;
a light emitting diode disposed above the substrate;
a color filter disposed above the light emitting diode;
an optical member in which a plurality of first refractive layers and a plurality of second refractive layers are alternately disposed in a horizontal direction, parallel to the substrate, above the color filter, wherein a refractive index of the plurality of first refractive layers is higher than a refractive index of the plurality of second refractive layers; and
an optical lens disposed above the optical member,
wherein light from the light emitting diode is refracted at an interface between each of the plurality of first refractive layers and an adjacent one of the plurality of second refractive layers at an angle that is larger than an incident angle with respect to the optical member to be incident on the optical lens.

18. A stereoscopic image display device, comprising:
a substrate comprising a plurality of sub pixels;
a light emitting diode disposed above the substrate;
a color filter disposed above the light emitting diode;
an optical member disposed above the color filter; and
an optical lens disposed above the optical member,
wherein light from the light emitting diode is refracted by the optical member at an angle larger than an incident angle with respect to the optical member, to be incident on the optical lens.

19. The stereoscopic image display device according to claim 18, wherein the optical member is disposed at an equal distance with respect to the color filter and the optical lens between the color filter and the optical lens.

20. The stereoscopic image display device according to claim 18, wherein the light from the light emitting diode is refracted at an interface between a first refractive layer and a second refractive layer in the optical member,
wherein the interface extends inclinedly from a bottom surface of the optical member to a top surface of the optical member.
